(19) United States
(12) Patent Application Publication
(10) Pub. No.: US 2014/0368904 A1
(43) Pub. Date: Dec. 18, 2014

(54) Software Defined Microscope

(71) Applicant: Agilent Technologies, Inc., Loveland, CO (US)

(72) Inventors: Manuel Moertelmaier, Wels (AT); Michael Dieudonne, Leuven (BE)

(73) Assignee: Agilent Technologies, Inc., Loveland, CO (US)

(21) Appl. No.: 14/470,835

(22) Filed: Aug. 27, 2014

Related U.S. Application Data
(63) Continuation of application No. PCT/US12/27152, filed on Feb. 29, 2012.

(51) Int. Cl. G02B 21/00; G02B 21/06

(52) U.S. Cl. CPC G02B 21/0076; G02B 21/06
USPC 359/385

(57) ABSTRACT

A microscope having a first illumination spatial light modulator (SLM) that receives light of a first wavelength from an illumination source and processes that light in a manner that transfers light into an objective lens through a dichroic reflector that passes light of the first wavelength is disclosed. The microscope includes an imaging system that receives light from the objective lens and forms an image on a camera, and a controller having a graphical user input that displays the image to a user and controls the first illumination SLM to alter the processing of the light in response to commands from the user. The illumination SLM is controlled to provide functions that would normally be carried out by one or more lenses or prisms in the illumination optical train of a conventional microscope and/or correct for alignment errors in the illumination source.

### CROSS REFERENCE TO RELATED APPLICATIONS

This is a continuation of International Application PCT/US12/27152 filed on 29 Feb. 2012.

### BACKGROUND

Advances in fluorescence microscopy, such as powerful lasers and sensitive cameras have now made possible the detection of single dye molecules in a living cell. The dye either binds directly to a component of the cell or is attached to a targeting molecule that binds to the cell component. However, implementing such single molecule imaging in a conventional microscope presents significant challenges.

The illuminating source must provide a number of features beyond merely illuminating an area of interest on a sample. In order to collect a sufficiently strong signal (hundreds to thousands of photons) from a single dye molecule within a few milliseconds, illumination intensities of more than 1 kW/cm² are required. However, the typical laser light source generates less than 100 mW. Only part of this power can be projected through the objective. Hence, the maximum area that can be illuminated is less than 100 microns in diameter. In practice, a large area is preferably illuminated to find the cells of interest. Then, a more intense localized illumination is employed in a smaller area around the cell of interest to increase the speed with which an image of the cell of interest can be formed and to reduce the photo-induced damage to surrounding cells that are not currently being imaged. Hence, size, location, and intensity of the illumination light spot must be variable.

In addition, the wavelength of the illuminating source may need to be varied depending on the dye in question. If the sample includes multiple dyes with different excitation wavelengths, the illuminating source may need to provide multiple wavelengths during the acquisition of the same image.

In addition to the issues raised by single molecule detection, in some modes of image formation, the angle at which the illuminating light strikes the sample must also be controlled. For example, in one mode of illumination, the incident light must strike the boundary between the slide on which the sample is located and the sample at an angle that ensures that the illuminating light will be totally reflected from that boundary. This method of illumination results in a small volume, close to the glass, being excited, which improves the signal-to-noise ratio of the image.

Finally, different illumination patterns are required for different modes of imaging. Modes in which the sample is illuminated with a pattern consisting of stripes, circles, rings or spots may be required depending on the imaging mode.

### SUMMARY

The present invention includes a microscope having a first illumination spatial light modulator (SLM) that receives light of a first wavelength from an illumination source and processes that light in a manner that transfers light into an objective lens through a dichroic reflector that passes light of the first wavelength. The microscope also includes an imaging system that receives light from the objective lens and forms an image on a camera, and a controller having a graphical user input that displays the image to a user and controls the first illumination SLM to alter the processing of the light in response to commands from the user. The illumination SLM is controlled to provide functions that would normally be carried out by one or more lenses or prisms in the illumination optical train of a conventional microscope. In addition, the controller can utilize the illumination SLM to correct for alignment errors in a light source that generates the light of the first wavelength by using the camera image to optimize the programming of the SLM. The imaging system can include an imaging SLM that is controlled by the controller, the imaging SLM imaging light from the dichroic reflector onto the camera. The controller can utilize the imaging SLM to correct for aberrations in the objective lens and perform polarization dependent processing of the light from the objective lens. The controller can also utilize the imaging SLM to generate images having enhanced spectral information for objects viewed by the objective lens.

### BRIEF DESCRIPTION OF THE DRAWINGS

FIG. 1 illustrates one embodiment of a microscope according to the present invention.

FIG. 2 illustrates one method of using a phase modulating SLM to replace an optical element.

FIG. 3 illustrates a light source having two monochromatic light sources of different wavelengths.

FIG. 4 illustrates another embodiment of a light source for use in a microscope according to the present invention.

FIG. 5 illustrates the field of view of a slide as seen in the camera image displayed on the GUI.

FIG. 6 illustrates the manner in which a total internal reflection imaging mode is implemented in a conventional microscope.

FIG. 7 illustrates the manner in which an SLM in a microscope according to the present invention can be utilized to provide off axis focusing without requiring a moveable focusing lens.

FIGS. 8A and 8B illustrate another embodiment of an input optical chain for use in a microscope according to one embodiment of the present invention.

FIGS. 9A and 9B illustrate a portion of the emission light processing optics according to two embodiments of the present invention.

FIGS. 10A and 10B illustrate the diffraction patterns for a conventional daisy lens and a super resolution daisy lens.

FIG. 11 illustrates one fluorescent spot in the field of view of the microscope when the SLM is programmed to provide the prism pattern.

### DESCRIPTION OF EMBODIMENTS OF THE INVENTION

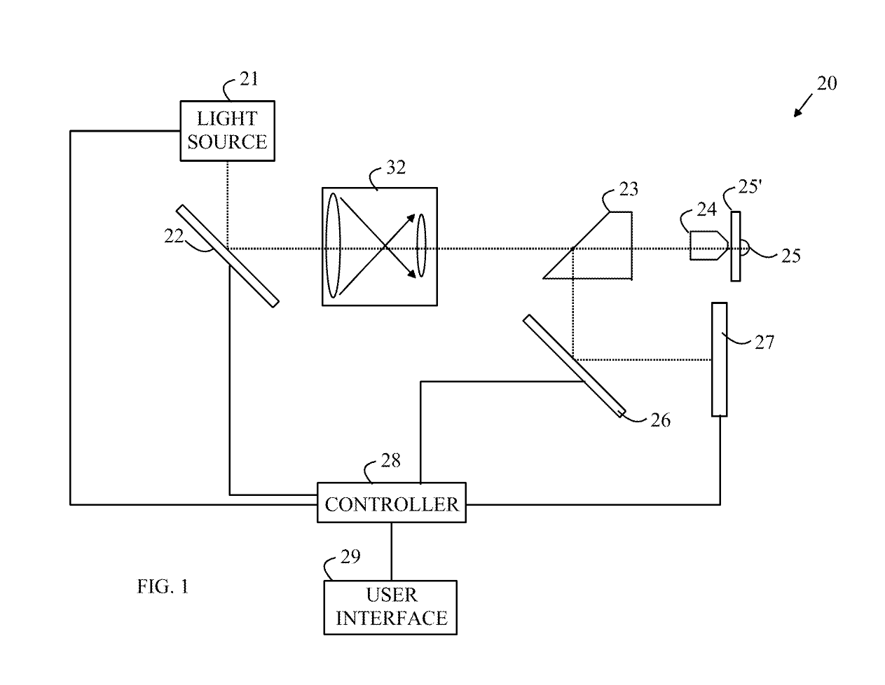

The manner in which the present invention provides its advantages can be more easily understood with reference to FIG. 1, which illustrates one embodiment of a microscope according to the present invention. Microscope 20 forms an image of a sample 25 that contains cells of interest on a slide 25′. The sample is illuminated by a light source 21 that can include a plurality of discrete wavelength light sources that are controlled by a controller 28 that communicates with a user of microscope 20 via graphical user interface (GUI) 29. The light from light source 21 is processed by an SLM 22 that alters the phase of the light from light source 21 to different degrees depending on the location with which the light strikes SLM 22. SLM 22 will be discussed in more detail below. The processed light from SLM 22 is imaged into objective lens 24 that focuses the light onto the sample. An optional telescope 32 reduces the size of the light beam output from SLM 22 such that the light beam will be accommodated by the input aperture of objective lens 24.

Dichroic reflector 23 passes light of the incident wavelength. SLM 26 also alters the phase of the light incident thereon. The light processed by SLM 26 is imaged onto a camera 27 whose output is input to controller 28. The image is displayed on GUI 29 in a manner that allows the user to communicate various control parameters that are used to adjust the processing provided by SLMs 22 and 26.

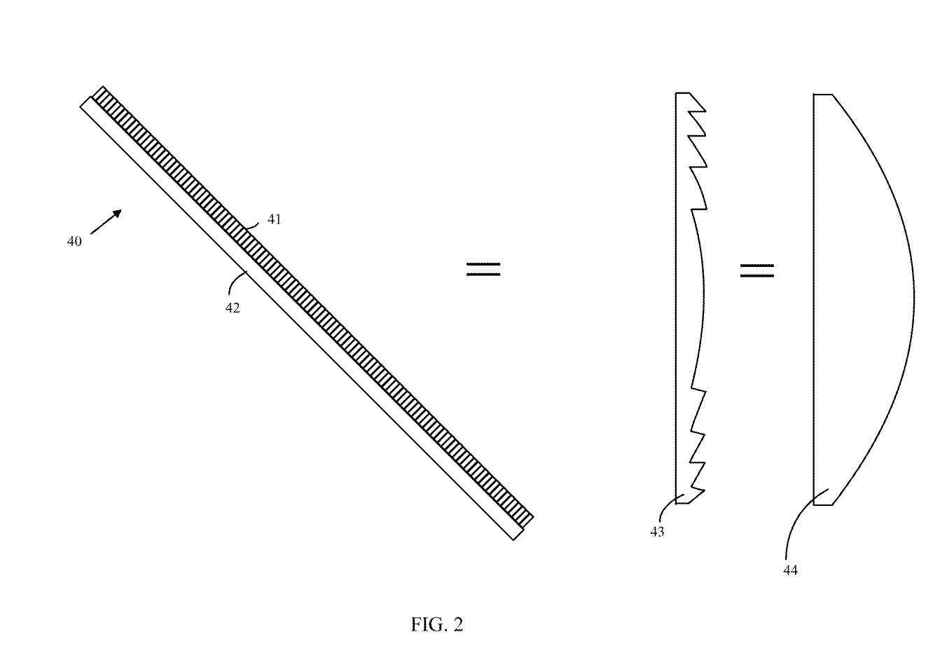

As noted above, the output of light source 21 is processed by SLM 22, which is a phase modulating SLM. Refer now to FIG. 2, which illustrates a phase modulating SLM. SLM 40 can be viewed as an array of clear pixels 41 on a reflecting substrate 42. The index of refraction of each pixel can be individually varied by applying an appropriate control voltage to electrodes within the pixel that are associated with each pixel. SLMs in this configuration can be implemented by depositing a liquid crystal material on a silicon substrate that includes the control circuitry and electrodes for controlling the individual pixels. SLMs of this type are commercially available, and hence, will not be discussed in detail here. For the purpose of the present discussion, it is sufficient to note that from the point of view of light passing through the pixel, a pixel with an index of refraction 3 and thickness of 1 unit has the same effect on the light as a pixel with an index of refraction of 1.5 and a thickness of 2 units. Hence, such an SLM can emulate a Fresnel lens as shown at 43, which, in turn, processes light in substantially the same manner as lens 44.

Similarly, a phase modulating SLM can emulate a prism for redirecting a light beam and for separating a broad spectrum light source into its component wavelengths. It should be noted that a single SLM can, in principle, simulate an optical assembly having a plurality of lenses and prisms. Given the desired optical processing, the equivalent phase shift pattern can be derived as an input to the SLM.

An SLM can also be used to create, within the limits of optical resolution, a near-arbitrary intensity distribution in the focal plane of a lens. The SLM is placed conjugate to the lens plane, with light reflected from the SLM passing through the lens. The intensity distribution in the focal plane of the lens will be the Fourier transform of the phase pattern on the SLM. There exist several published methods for computing SLM settings based on the desired intensity distribution.

An SLM can, in principle, provide the same input light processing as that provided by conventional optical assemblies used in non-SLM containing microscopes at a significantly reduced cost. Conventional input optical trains must be constructed for components that must utilize achromatic lenses and elements, as the wavelength of the input light may vary depending on the particular application. In addition, the alignment tolerance of the elements is small, since the end user cannot easily alter the alignment.

An SLM can alter the effective focal length of the simulated lens electronically when the wavelength of the light source is changed. In addition, the SLM can electrically “move” the position of the lens or change the angle of a reflector relative to the other fixed optical elements. Hence, these parameters can be changed during the setup and running of an experiment, either automatically or in response to input from the user.

For example, the position and size of the illumination spot in the field of view of the microscope can be controlled using software that adjusts the pattern of pixels on the SLM to provide a desired beam shape and size in the field of view as seen by the camera. Consider the case in which light source 21 is constructed from a plurality of monochromatic light sources such as lasers. Typically, the experiment requires that the lasers generate spots at the same location with the same shape in the field of view of the microscope. The alignment of the individual light sources presents significant challenges in a conventional microscope, since the alignment must be controlled by some form of mechanical assembly that can correct for alignment errors.

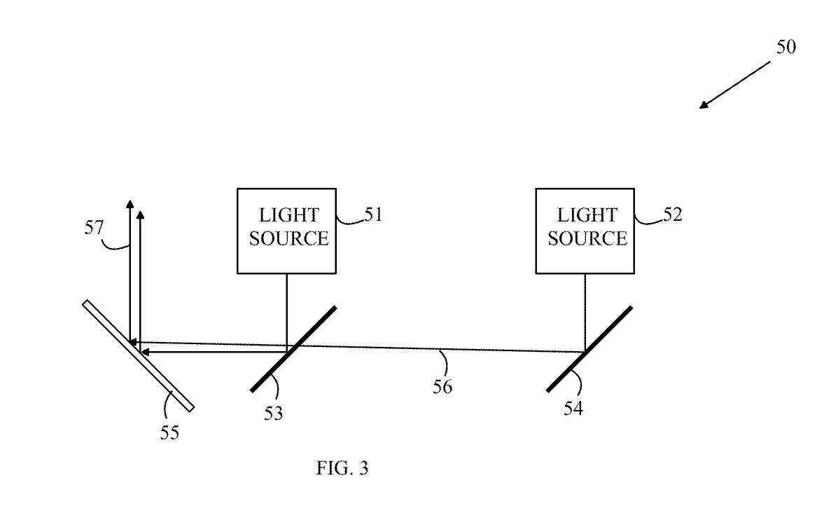

Refer now to FIG. 3, which illustrates a light source 50 having two monochromatic light sources of different wavelengths. Consider the case in which only one of the light sources is active at any given time, and one of the light sources is out of alignment. The light from the two sources shown at 51 and 52 is combined with the aid to dichroic reflector 53 and a mirror 54. Ideally, each light source produces a light beam in the direction shown at 57. Because of an alignment error, the light from light source 52 is misaligned as shown at 56. The misalignment is corrected by SLM 55. When light source 52 is active, the position of the resultant spot in the field of view is measured with camera 27 shown in FIG. 1. The SLM program is set such that the spot is at the desired location by programming the SLM to emulate a prism as well as a reflector. The prism corrects for the misalignment. When light source 51 is active, the SLM is programmed to be a simple reflector. As noted above, the SLM can also emulate a lens in conjunction with a prism, and hence, if the beams are to be focused, the SLM can also provide the desired lens emulation. Furthermore, since the light from each source is monochromatic, the SLM can be programmed to provide the prism and/or lens that operates properly on that wavelength, and hence, an expensive achromatic lens is not required.

This arrangement also allows experiments in which light is switched rapidly from one wavelength to another without the position of the illuminated spot changing. Experiments in which the sample is primed with one wavelength and then viewed with a second wavelength can be easily accommodated.

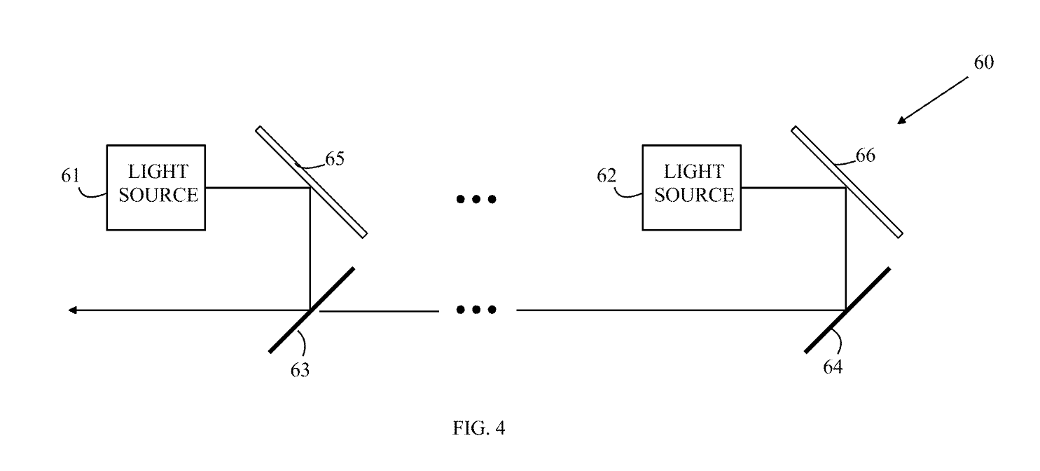

If multiple light sources are to be operated at once, an arrangement in which each light source has its own SLM can be utilized. Refer now to FIG. 4, which illustrates another embodiment of a light source for use in a microscope according to the present invention. Light source 60 has a number of monochromatic light sources of which light sources 61 and 62 are typical. Each light source has a corresponding SLM as shown at 65 and 66. The SLMs are programmed to correct for alignment errors and any focusing requirements for the associated light source by observing the spot on the camera and correcting the SLM program until the spot is at the desired location and has the desired shape. The light beams generated by the individual light sources are then combined using dichroic reflectors such as reflectors 63 and 64.

The ability to control the location, size, and shape of the illumination spot in the field of view of the microscope allows a microscope according to the present invention to operate in a more efficient manner and with components that have a reduced cost compared to traditional microscopes.

In a traditional microscope, the user first inspects the field of view through a low-magnifying objective lens and shifts the stage to a region of interest that may include cells of interest. The user then switches to a higher magnification to find cells of interest. The user then centers a cell of interest via a motorized x-y stage such that the cell of interest is in the center of the field of view and the illumination is at an appropriately high level to perform the desired measurements. The user then switches the optical system to the camera to make the desired measurements. The cost of the precision stage is significant. In addition, the process of centering the cells of interest is time consuming.

In a microscope according to one embodiment of the present invention, the user performs all of these operations by viewing the camera output and the objective lens at the highest magnification. The camera has sufficient resolution to allow digital zooming to any sub-area of interest. The SLM is programmed to illuminate the entire area that can be viewed by the user on the camera. The user selects interesting cells using a mouse or other pointing device that is part of the GUI. The SLM then alters the size of the spot and position to the location indicated by the user. Since all of the light is now concentrated in the region indicated by the user, the illumination intensity is substantially higher resulting in faster imaging. In addition, the required precision of the microscope stage is substantially reduced, since the fine tuning of the position is provided by the area of the camera field of view selected by the user, not by a fixed field of view in which the user must center the cell of interest.

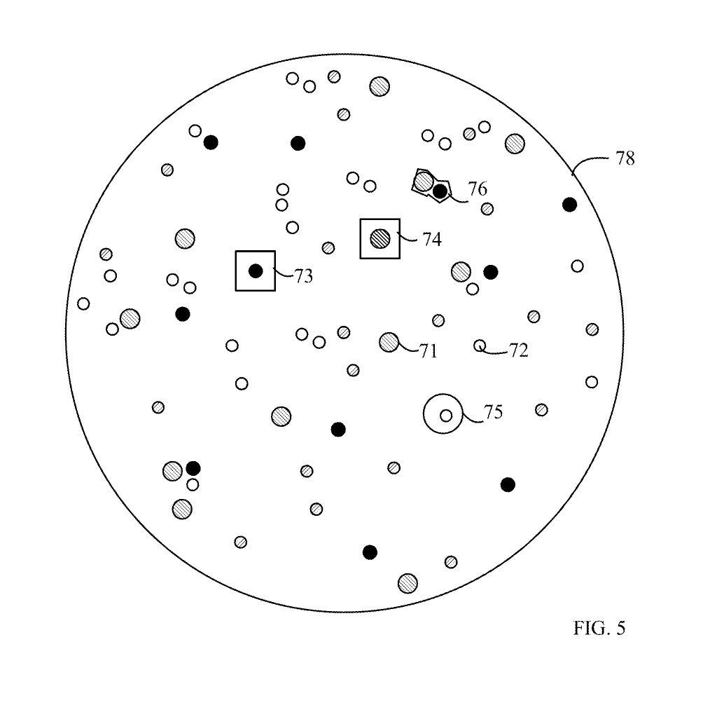

The ability of the SLM to control the shape of the spot on the specimen as well as moving the location allows for more efficient illumination of the object of interest as well as avoiding nearby objects that could interfere with the measurement of interest. Refer now to FIG. 5, which illustrates the field of view of a slide as seen in the camera image displayed on the GUI. The image is taken with the illumination spot size set to illuminate all of the objects in the field of view 78. Exemplary cells are shown at 71 and 72. The user can select an area to be illuminated at high intensity by marking the boundaries of the sub-field that is to be illuminated as shown at 73-75. The user can also specify the shape of the illumination sub-field. The shapes can be selected from a predetermined menu of shapes such as squares, rectangles, or circles. In addition certain free-form shapes could be provided such as boundary shown at 76. By choosing a shape that more nearly matches the boundary of the object of interest, the light is concentrated where it is needed and background light is reduced.

The user then indicates that one of the chosen sub-fields is to be subjected to higher illumination at a specified wavelength. The controller coverts the location and boundary of the spot into a pattern that is to be applied to the SLM, and the camera records the image. During this later phase, only the area indicated by the user is illuminated. In the case of predetermined shapes, the pattern can be stored in the controller. For a more free-form pattern, the controller would need to compute the required SLM pattern. Computer programs for determining an SLM pattern to generate a known spot size at a known location are known to the art, and hence, will not be discussed in detail here.

In some experiments, the angle with which the illumination light strikes the bottom surface of the slide on which the specimen is located is critical. For example, in total internal reflectance imaging, the illumination light strikes the slide at an angle such that the light is reflected at the interface between the glass and the specimen due to the difference in the index of refraction of the glass and specimen-containing fluid. This arrangement gives rise to an evanescent electric field within the specimen that excites the specimen for imaging. The resulting images have higher contrast than images taken with more conventional illumination. To provide this experimental arrangement, the slide must be illuminated with a parallel beam of light at an angle greater than the critical angle.

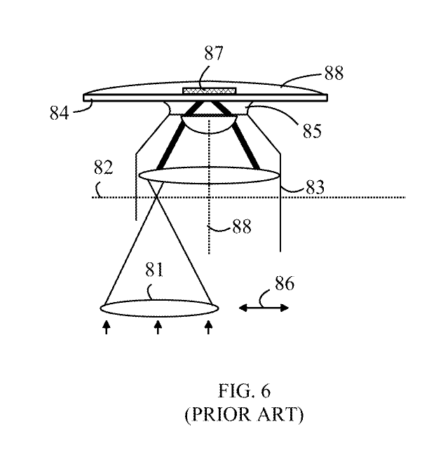

Refer now to FIG. 6, which illustrates the manner in which a total internal reflection imaging mode is implemented in a conventional microscope. The sample 88 is mounted on a slide 84 that is illuminated from below to create evanescent electric field region 87. The illumination system requires a separate focusing lens 81 that focuses the parallel light beam from the laser onto the back focal plane 82 of objective lens 83. Light leaving the objective lens with this arrangement will be in a parallel beam. The angle of the parallel beam relative to the axis of the objective lens is determined by the displacement of the focal point in back focal plane 82 relative to the axis 88 of the objective lens. This displacement requires that focusing lens 81 be moved laterally as shown by arrows 86. The cost of this arrangement is significant. First, focusing lens 81 needs to be achromatic, since any of a number of different excitation wavelengths may be needed. Second, focusing lens 81 must be mounted in a moveable mount whose position can be easily adjusted and which can be removed when conventional illumination is desired.

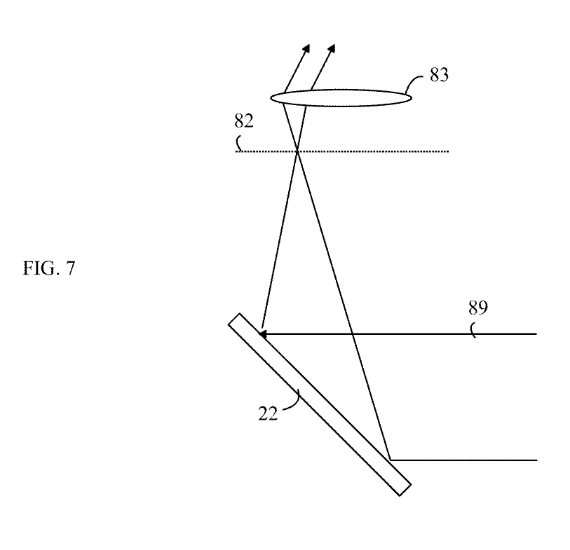

Refer now to FIG. 7, which illustrates the manner in which an SLM in a microscope according to the present invention can be utilized to provide the desired focusing without requiring a moveable focusing lens. In this embodiment, SLM 22 shown in FIG. 1 is programmed to provide an off-axis focusing lens that focuses the laser light 89 to the correct position on the back focal plane of objective lens 83. When the illumination system is used in a conventional mode, the SLM is merely reprogrammed to the corresponding pattern in that mode.

If the SLM cannot provide the narrow focus needed for the total internal reflection mode and still provide the illumination patterns needed for conventional illumination, a second SLM can be provided in the input illumination chain. For total internal reflection mode, the SLM needs to be farther from the objective lens than in the case of illumination that is directed to illuminating a spot that can be moved in the field-of-view. The two different distances can be accommodated by using two different spaced apart SLMs in the input light section.

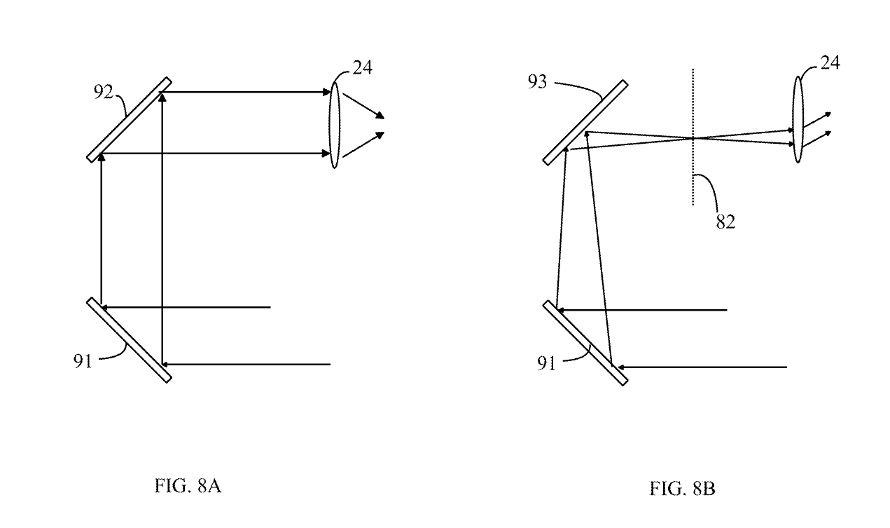

Refer now to FIGS. 8A and 8B which illustrate another embodiment of an input optical chain for use in a microscope according to one embodiment of the present invention. FIG. 8A illustrates the input chain processing when conventional illumination is desired, and FIG. 8B illustrates the input chain processing when total internal reflection illumination is desired. In this embodiment, two SLMs are utilized. Referring to FIG. 8A, the input chain uses SLM 91 and SLM 92. When operating in a non-internal reflection mode, SLM 91 merely acts as a reflector and SLM 92 is programmed to provide the desired illumination pattern on the specimen. In one aspect of the invention, SLM 92 is positioned in a plane that is substantially conjugate to the back focal plane 82 of the objective. Referring to FIG. 8B, when operating in total internal reflection mode, SLM 91 is used to provide the off-center Fresnel lens pattern to focus the laser beam onto the back focal plane of the objective lens 24, and SLM 93 is programmed to be a simple reflector.

Refer again to FIG. 1. In one aspect of the present invention, the emission light pipe also includes an SLM for providing programmable optics in the emission path. Using an SLM in the emission path is complicated by the requirement that an SLM process polarized light. This does not present a significant issue in the input light path, since the polarization of the laser source can be properly aligned. In the emission path, the available light intensity cannot be so offset to make up for losses incurred by polarization filters that reduce the available light by a factor of two.

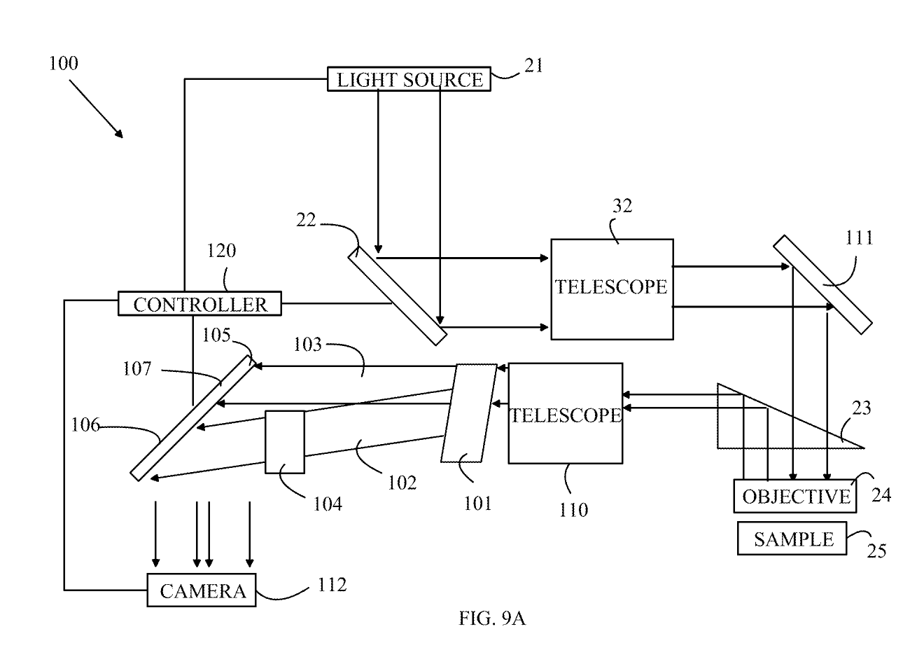

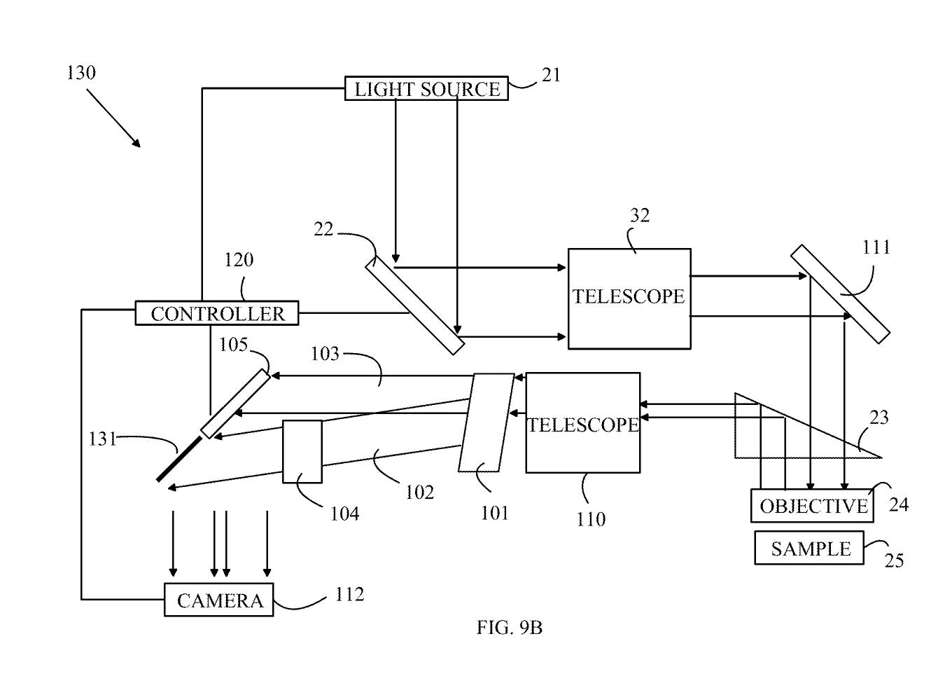

Refer now to FIG. 9A, which illustrates a portion of the emission light processing optics according to one embodiment of the present invention. To simplify the following discussion those elements of microscope 100 that serve functions analogous to elements in FIG. 1 have been given the same numeric designations. Microscope 100 includes a mirror 111 that folds the optical path to provide a more compact apparatus.

In this arrangement, a polarization-dependent beam splitter 101 receives the light from the sample. Polarization-dependent beam splitter 101 separates the light into two beams traveling in different directions and having different orthogonal polarizations as shown at 102 and 103. A telescope 110 matches the output of the objective lens to the input of polarization-dependent beam splitter 101. A polarization rotating element 104 rotates the polarization of one of the beams to the desired polarization for SLM 105. This beam is incident on a region 106 of SLM 105 that is separate from region 107 at which beam 103 strikes SLM 105. SLM 105 is programmed by controller 120 to provide two separate SLMs that are located next to one another. The outputs of each section can be imaged onto different regions of camera 112 to provide two images with light having different polarizations. Alternatively, the two light beams can be recombined after processing by using another rotating element and polarization-dependent beam splitter to reverse the process used to separate the two light beams.

In the embodiments shown in FIG. 9A, the imaging SLM process both of the images created by the polarization-dependent beam splitter are processed by different portions of SLM 105. This divides the pixels of SLM 105 between the two images, and hence, reduces the resolution of the SLM that can be applied to each image.

Refer now to FIG. 9B which illustrates a portion of the emission light processing optics according to another embodiment of the present invention. To simplify the following discussion those elements of microscope 130 that serve functions analogous to elements in FIG. 9A have been given the same numeric designations. Microscope 130 differs from microscope 100 in that SLM 105 is used to process the light from beam 103, and the light from beam 102 is just reflected into the camera by mirror 131. This arrangement provides two side-by-side images in the camera, one that has been processed by SLM 105 and one that has not been so processed. For example, in the case in which SLM 105 is used to change the depth of focus of the objective lens, the images represent a conventional image and an image that is limited to a narrower band of positions in the sample.

In one aspect of the invention, the SLM in the emission path is also used as a programmable lens to correct for errors in the objective lens such as spherical aberration, coma, and astimatism. The correction is accomplished by analyzing the camera images for a known calibration target and iteratively improving the SLM pattern until sufficient compensation is achieved. This aspect of the present invention allows for a less expensive objective lens to be used in the microscope. It should also be noted that the usable field-of-view of the microscope, even with a good quality objective lens, is limited by the above-described optical imperfections, and hence, this aspect of the present invention also allows for a larger field-of-view.

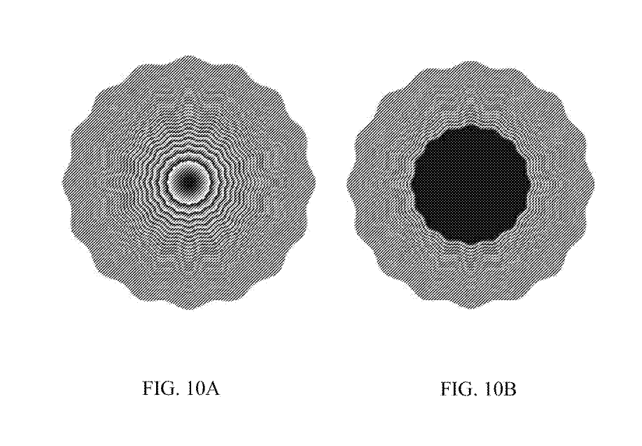

In another aspect of the invention, the SLM in the emission path is programmed such that the combination of the objective lens and SLM emulate a “super resolution lens”. In a super resolution lens, the center region of the lens is blocked. This gives rise to an image in which higher spatial frequencies in the image are enhanced at the cost of introducing some artifacts into the image. The artifacts can be made less objectionable by using a so-called super resolution daisy lens. The Fourier diffraction pattern for a conventional daisy lens and a super resolution daisy lens are shown in FIGS. 10A and 10B, respectively.

The programmable lens aspect of the invention can also be used to locate the fluorescent molecules in terms of the depth of the molecules within the sample. Here, the additional focal lens provided by SLM changes the focal length of the combination of the SLM lens and the objective lens. In addition, the depth of focus is decreased such that only molecules at a known distance from the bottom of the slide are in focus.

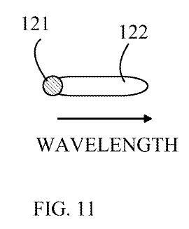

In another aspect of the invention, the SLM in the emission path is also used to create a spectroscopic display for each of the elimination points in the image. The SLM is programmed with a Fresnel prism pattern in these embodiments of the present invention. Refer now to FIG. 11, which illustrates one fluorescent spot in the field-of-view of the microscope when the SLM is programmed to provide the prism pattern. The prism spreads the light at each point 121 into a “streak” 122 in which the positions in the streak correspond to different wavelengths. Hence, the camera measures a spectrum corresponding to each of the illuminated points in the image. Since the spectrum of the fluorescent dye is known, this spectrum can be used to improve the signal-to-noise ratio by fitting the spectrum to the known spectrum plus a background.

It should be noted that two SLM patterns can be implemented as two side-by-side patterns on the SLM, which gives rise to side-by-side images on the camera. The two patterns could provide two lenses of different focal lengths so that the amount of defocusing can be used to localize objects in three dimensions. Alternatively, or in combination, one of the lenses can include the prism pattern in conjunction with a lens pattern to show the original image and one with spectra.

The capability of the system to reconfigure itself purely through software changes allows for rapid changes between measurement modes. Also, the system can be upgraded to new measurement modes after deployment. The user can also design new modes and protocols without having to perform modifications to the hardware.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A microscope comprising:
a first illumination spatial light modulator (SLM) that receives light of a first wavelength from an illumination source and processes that light in a manner that transfers light into an objective lens through a dichroic reflector that passes light of said first wavelength;
an imaging system that receives light from said objective lens and forms an image on a camera;
a controller having a graphical user input that displays said image to a user and controls said first illumination SLM to alter said processing of said light in response to commands from said user.

2. The microscope of claim 1 wherein said controller selectively illuminates a region of said sample specified by a user on said GUI.

3. The microscope of claim 1 wherein said controller causes said first illumination SLM to emulate a Fresnel lens in one mode of illumination.

4. The microscope of claim 1 wherein said controller causes said first illumination SLM to emulate a Fresnel prism in one mode of illumination.

5. The microscope of claim 1 wherein said light source comprises a plurality of light sources, and wherein said controller corrects for alignment errors in said light sources utilizing said image from said camera.

6. The microscope of claim 1 wherein said objective lens is characterized by a back focal plane and a lens axis that passes through the center of said objective lens, and wherein said controller causes said first illumination SLM to emulate a lens that focuses said light onto said back focal plane at a position offset from said lens axis.

7. The microscope of claim 1 wherein said controller processes said light such that a sample viewed by said microscope is illuminated in one of a plurality of patterns chosen by said user with said GUI.

8. The microscope of claim 7 wherein said controller processes said light such that said camera receives a first image of a first field of view of said sample, said image being displayed on said GUI.

9. The microscope of claim 8 wherein said controller processes said light such that said light is concentrated at a sub-field of said first field of view at a location input through said GUI by reference to said first image, said sub-field being less than said first field of view.

10. The microscope of claim 6 further comprising a second illumination SLM, said second illumination SLM being displaced from said first illumination SLM and receiving light processed by said first illumination SLM, wherein said controller controls said first and second illumination SLMs such that one of said first and second illumination SLMs is positioned to focus said light onto said back focal plane at said position offset from said lens axis and the other of said first and second illumination SLMs is positioned substantially in a plane conjugate to a back focal plane of said objective.

11. The microscope of claim 1 wherein said imaging system comprises an imaging SLM that is controlled by said controller, said imaging SLM imaging light from said dichroic reflector onto said camera.

12. The microscope of claim 11 wherein said controller causes said imaging SLM to correct for aberrations in said objective lens.

13. The microscope of claim 11 further comprising a polarization beam splitting assembly that receives light from said dichroic reflector, splits that light such that light of a first polarization strikes said imaging SLM in a first region of said imaging SLM and light of the orthogonal polarization is passed through a polarization rotating assembly and strikes said imaging SLM in a second region that is separated from said first region.

14. The microscope of claim 11 further comprising a polarization beam splitting assembly that receives light from said dichroic reflector, splits that light such that light of a first polarization strikes said imaging SLM and light of an orthogonal polarization is imaged to said camera.

15. The microscope of claim 13 wherein said controller causes said imaging SLM to form a first image from said light striking said imaging SLM in said first region on said camera and a second image from light striking said imaging SLM in said second region, said first image being separate from said second image in said camera.

16. The microscope of claim 11 wherein said controller causes said imaging SLM to emulate a Fresnel prism that generates a spectral enhanced image of a sample viewed with said microscope.

17. The microscope of claim 11 wherein said objective lens and said imaging SLM are characterized by a depth of focus in said sample and wherein said controller causes said imaging SLM to alter that depth of focus.

18. The microscope of claim 11 wherein said controller causes said imaging SLM to emulate a lens having a center section blocked.

19. The microscope of claim 19 wherein said lens is a super-resolution Daisy lens.
